(19) United States
(12) Patent Application Publication
(10) Pub. No.: US 2007/0164999 A1
(43) Pub. Date: Jul. 19, 2007

(54) Optical navigation module and lens having large depth of field therefore

(76) Inventor: Russell W. Gruhlke, Fort Collins, CO (US)

Correspondence Address: AVAGO TECHNOLOGIES, LTD., P.O. BOX 1920, DENVER, CO, 80201-1920, US

(21) Appl. No.: 11/334,559

(22) Filed: Jan. 19, 2006

(51) Int. Cl. G09G 5/08

(52) U.S. Cl. 345/166

(57) ABSTRACT

An optical navigation module includes a body having a base which rests on a surface with respect to which the optical navigation module moves; a lens disposed in the body and having a large depth of field that is longer than a distance between the lens and the surface so as to form an image of another surface other than the surface; a light sensor disposed in the body and which detects the formed image of the another surface; and a controller to use the detected image to determine a motion of the another surface relative to the optical navigation module and which is independent of the surface on which the base rests.

### BACKGROUND OF THE INVENTION

1. Field of the Invention

Aspects of the invention relate to an image motion sensor using a lens with a large field of view, and more particularly, to an optical navigation module using the lens for navigating on a glass surface.

2. Description of the Related Art

Conventionally, optical navigation modules (i.e., computer mice) come in a wide variety of shapes having different features and sizes and prices. Computer mice are divided up according to how the motion is sensed. Specifically, optical mice use optical motion sensing. In contrast, mechanical mice use mechanical motion sensing. While the mechanical mice were the earlier of the two types of computer mice, the optical mice have begun to gain increased acceptance.

Early versions of optical mice relied upon fine lines on a specific grid in order to perform tracking operations. However, with the advent of an optical position sensor by Agilent Technologies in 1999, optical mice are now able to work on a wide variety of surfaces without requiring the fine line grids. The optical position sensor works by taking a picture of the surface on which the mouse is navigating, and comparing images taken sequentially to detect the speed and direction of the movement of the surface relative to the mouse. In this manner, the optical mouse is able to navigate across a wide variety of surfaces without requiring such a grid.

In contrast to early optical mice and mechanical mice which used a ball to perform the tracking operation, an optical mouse typically does not use a ball. Specifically, the mouse includes a clear lens underneath. Light from a light source (generally an LED emitting a red and/or infrared wavelength light) reflects off the surface and is received through a window at the lens. The lens is designed to focus light reflected from a surface that is typically a few tens of centimeters from the lens. The lens focuses the received light on a sensor, which detects the image. As such, as the mouse is moved, the sensor takes continuous images of the surface and compares the images to determine the distance and direction traveled utilizing digital signal processing. The results are then sent to the computer or other computational device in order to move the cursor on the screen.

Such transmission to the computer can be either directly through a cord, which often supplies energy for use in powering the mouse, or using a cordless mouse, which uses RF technology or Bluetooth in order to transmit the navigational data to the computer. Where a cordless optical mouse is used, an onboard power source such as a battery is used in order to power a light source and a sensor of the mouse.

While suitable for opaque surfaces, the use of reflected light is not possible where the surface is transparent, such as on a desk with a glass surface. In this situation, the surface reflects an insufficient amount of the light to perform optical navigation since the majority of the light passes through the transparent surface. As such, the images become featureless, rendering the image correlation process ineffective.

### SUMMARY OF THE INVENTION

Aspects of the invention relate to a motion sensing apparatus utilizing a lens with a large depth of field to perform optical navigation independent of a surface on which the apparatus rests.

Additional aspects and/or advantages of the invention will be set forth in part in the description which follows and, in part, will be obvious from the description, or may be learned by practice of the invention.

According to an aspect of the invention, optical navigation module includes a body having a base which rests on a surface with respect to which the optical navigation module moves; a lens disposed in the body and having a large depth of field that is longer than a distance between the lens and the surface so as to form an image of another surface other than the surface; a light sensor disposed in the body and which detects the formed image of the another surface; and a controller to use the detected image to determine a motion of the another surface relative to the optical navigation module and which is independent of the surface on which the base rests.

According to an aspect of the invention, the surface is transparent and is between the body and the another surface being imaged by the lens.

According to an aspect of the invention, the surface comprises a desktop of a desk, and the another surface is a floor on which the desk rests.

According to an aspect of the invention, the lens focuses light on the floor through a window in the base and through the transparent desktop surface.

According to an aspect of the invention, the body is between the another surface and the surface.

According to an aspect of the invention, the surface comprises a desktop of a desk, and the another surface is a ceiling of a room including the desk.

According to an aspect of the invention, the controller detects the motion without an image of the surface.

According to an aspect of the invention, the lens has a depth of field that is greater than a distance between the lens and the surface.

According to an aspect of the invention, the lens has a depth of field that is up to infinity.

According to an aspect of the invention, the lens has a depth of field that is greater than a distance between the lens and the surface and is up to infinity.

According to an aspect of the invention, the depth of field is 25 cm to infinity.

According to an aspect of the invention, where the optical navigation module further includes a lift-off detection system which detects when the body has been removed from the surface, and the controller stops detecting the motion when the lift-off detection system detects that the body has been removed from the surface.

According to an aspect of the invention, the light sensor comprises an 800 count per inch sensor.

According to an aspect of the invention, the light sensor comprises a CMOS sensor.

According to an aspect of the invention, the optical navigation module further comprises a light source which illuminates the another surface.

According to an aspect of the invention, the light source comprises a light emitting diode (LED).

According to an aspect of the invention, the controller controls the light source to be on when there is insufficient ambient light to determine the motion and controls the light source to be off when there is sufficient ambient light.

According to an aspect of the invention, the optical navigation module further includes a user input to allow a user to control the light source to be on and control the light source to be off.

According to an aspect of the invention, the optical navigation module comprises a computer mouse.

According to an aspect of the invention, the computer mouse comprises a wireless transmitter and receiver to transmit and receive data with respect to a computer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a profile view of an optical navigation module usable on a transparent surface according to an embodiment of the invention;

FIG. 2 is a schematic view of a downward the field of view for the optical navigation module shown in FIG. 1 according to an aspect of the invention; and

FIG. 3 is a schematic view of an upward field of view for the optical navigation module shown in FIG. 1 according to an aspect of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

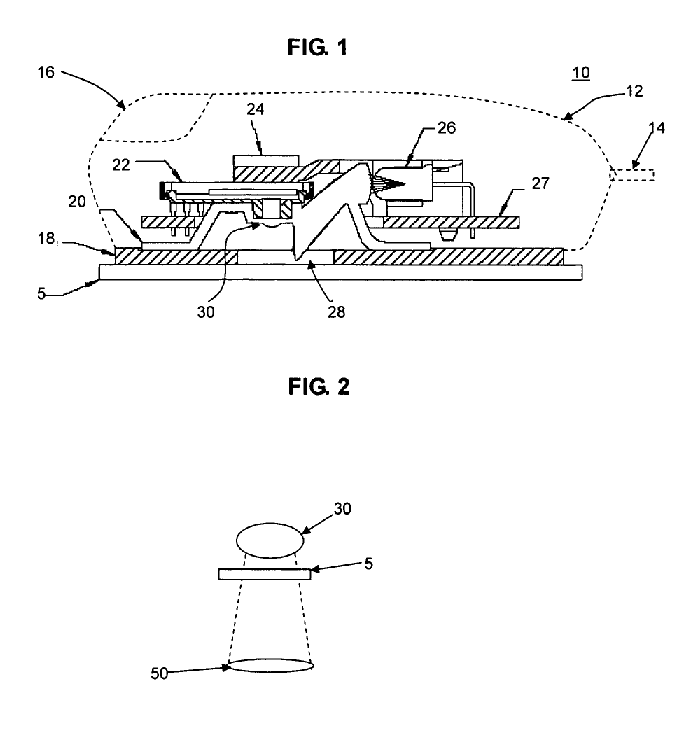

FIG. 1 shows an example of an optical navigation module according to an aspect of the invention. As shown, the optical navigation module corresponds to a mouse 10. The mouse 10 rests on and moves relative to a surface 5. The mouse 10 includes a body 12 on top of a base plate 18. The body 12 is generally shaped to fit in the palm of a hand, and is often ergonomically shaped. The body 12 further may be opaque according to an aspect of the invention. Alternately, the body 12 may be translucent in order to allow light to pass to the surface in order to be used to perform optical navigation according to an aspect of the invention.

Extending from the body 12 is a cord 14. The cord 14 transfers power and/or detected direction signals with respect to a computer or other device (not shown) to which the optical navigation module is connected. However, it is understood that the cord 14 may be replaced by a transmitter for a wireless mouse 10, and/or that power may be internally supplied instead of being transferred from a computational device.

On top of the body 12 is a button or button array 16. The button array 16 is used by a user to input signals, such as by clicking. However, it is understood that a button 16 is not required in all aspects of the invention, and it is possible to input signals through other mechanisms, as in the case of game controllers, or to integrate the button into the connection between the body 12 and the base 18 to input signals by pressing the body 12.

The mouse 10 includes an internal kit used to detect motion due to relative motion of reflected light as detected by comparing images. As shown in FIG. 1, the kit generally corresponds to the Agilent ADNK-2133 optical mouse designer's kit (as described in the Agilent ADNK-2133 Optical Mouse Designer's Kit Product Overview), the disclosure which is incorporated herein by reference. However, it is understood that other types of kits (such as that described in the Agilent ADNK-3043-ND24 USB 2.4 GHz RF Wireless Low-Power Mouse Designer's Kit Product Over, the disclosure of which is incorporated by reference) can be used according to aspects of the invention. As shown, a light source 26 outputs a light beam which is reflected through a lens pipe 20 to provide light through an opening in the base plate 18. The light source 26 can be an LED or a laser according to aspects of the invention.

Since aspects of the present invention use ambient lighting to perform optical navigation, it is understood that the light source 26 is optional and/or could be used only when ambient light is insufficient for the purposes of providing an image. Where the light source 26 is used only periodically, the mouse 10 further comprises an input to manually turn the light source 26 on and/or a light sensor which detects when the light source 26 is required to perform illumination according to aspects of the invention. Alternately, the light source 26 can be automatically controlled by the chip 24 or another controller which detects when the ambient illumination is insufficient to provide an image satisfactory to perform optical navigation.

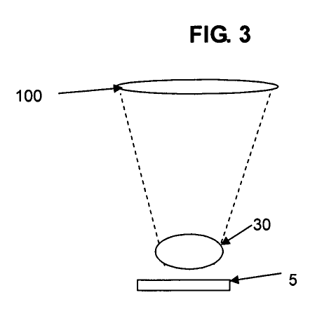

Moreover, while the lens pipe 20 is shown in FIG. 1 and is used to direct light from the light source 26 to illuminate a desired surface, it is understood that the lens pipe 20 need not be used in all aspects of the invention. Further, while shown as being used to direct light down towards a floor 50 or other lower surface, it is understood that the lens pipe 20 can be shaped to direct the light towards other surfaces to be illuminated. For instance, as shown in FIG. 2, the lens pipe 20 would be shaped to direct light at a floor 50, whereas in FIG. 3, the lens pipe 20 would be shaped to direct light at a ceiling 100. Alternately, the lens pipe 20 could be adjustable by a user in order to direct the light at other surfaces in order to allow the user to choose other surfaces relative to which optical navigation is to be performed.

The reflected light passes through a window 28 in the base plate and is received at a lens 30 according to an aspect of the invention. However, it is understood that, when the image is of a surface above the mouse 12 (such as the ceiling 100 shown in FIG. 3), a light guidance system could be used to direct light reflected back down from that surface into the lens 30. For instance, while shown in the context of only directing light from the light source 26, it is understood that the same or other lens pipe 20 or like light guidance module could be used to direct light reflected from the illuminated surface through the body to be focused by the lens 30. Examples of such light guidance modules include prisms, mirrors, reflective surfaces, and other like optical path changing devices. Alternately, the lens 30 and/or window 28 can be otherwise located to receive the downward reflected light.

As shown, the lens 30 is a single lens. However, it is understood that other types of lenses and lens arrays can be used to perform focusing.

The light is focused by the lens 30 onto a sensor 22 to produce an image of a surface other than the surface 5 on which the mouse 10 rests. In this manner, the image itself is independent of the surface 5. It is noted that, where the image is of the ceiling 100 or of another surface obstructable by the user while using the mouse (e.g., such by the user's hand), the lens pipe 20, the lens 30, and/or the light source 26 would need to be arranged in the body 12 so as to be able to capture the image without obstruction by the user during normal operation of the mouse 10.

The sensor 22 can be a conventional CMOS image sensor or a CCD sensor according to aspects of the invention. By way of example, the sensor 22 can be a conventional optical sensor used in optical mice, such as those having a 20×20 to 50×50 pixel image sensor and/or a sensor 22 having 800 counts per inch (cpi), but are not limited thereto. However, it is understood that additional and/or fewer pixel amounts and sizes can be used so long as the sensor 22 is able to perform imaging.

The image detected at the sensor 22 is detected by a chip 24. The chip 24 performs a comparative analysis over time of successive images in order to determine a direction and speed of the movement of the mouse 10. Specifically, the chip 24 includes firmware which compares present images detected by the pixels of the sensor 22 with images taken at a previous time, and the difference reveals the relative motion of the mouse 10 to the surface 5. However, since the images are not of the surface 5 itself, the optical navigation is performed independent of the transparent properties of the surface 5. Moreover, if the images are not of a surface below the surface 5, such as is shown in FIG. 3, aspects of the invention allow optical navigation independent of the optical properties of the surface 5. The resulting output is output through the cord 14 using a PCB 27. However, it is understood that various elements of the shown mouse 10 need not be used in all aspects of the invention.

While existing optical navigation modules use a lens which is designed to focus on a surface that is a few tens of centimeters from the lens 30, the lens 30 of an aspect of the invention is designed for long depths of field. Examples of such lenses are doublet lenses and/or lenses used in camera phones. Such camera phone lenses generally have an infinite depth of field/focal length, and are thus useful for ranges from that of a typical desk top above a floor (i.e, about 73 to 86 centimeters (29 to 30 inches)) as shown in FIG. 2, or from the surface 5 to the ceiling 100 (i.e., about 155 centimeters to 201 centimeters (61 inches to 79 inches)). Moreover, such lenses have other ranges so as to capture other objects off of the surface 5 which can be used for optical navigation (e.g., objects imbetween the floor 50 and the ceiling 100, such as a leg of a user, light fixtures, or portions of a chair).

While not required in all aspects, the lens 30 has an aperture of at or between 2 mm and 5 mm, and has an image focal length (i.e., from the lens 30 to the sensor 22) on the order of 10 mm or less. While not restricted thereto, an example lens 30 include that used in a VGA Camera Module (Standard) produced by Sunyang DNT, which includes a lens having dual plastic aspheric lenses to produce a focus range of 25 cm to infinity and an image focal length of 3.65 mm.

Moreover, while not required in all aspects, it would be possible to use camera modules, which often include a combined lens 30 and sensor 22. By way of example, the VGA Camera Module (Standard) produced by Sunyang DNT includes the lens and a CMOS sensor with 640×480 pixels. In this embodiment, the functionality of the mouse 10 can be combined with that of a camera. This aspect of the invention would be useful for portable applications, thereby allowing a camera or a camera phone to be used as a mouse for a computer without requiring a separate travel mouse. As such, the lens 30 could be used in travel applications, such as for providing optical navigation for smaller portable electronic devices like cell phones and personal digital assistants.

While not required in all aspects, the lens 30 could also image objects appearing imbetween the surface 5 and the floor 50 or the surface 5 and the ceiling 100, or be adjustable to focus on the floor 50/ceiling 100 or the imbetween object in order to improve optical navigation. Such focusing mechanisms include liquid lenses and/or aperture adjustments to increase the sharpness of the resulting image.

According to a further aspect of the invention, the mouse 10 further includes a lift-off detection system which detects when the mouse 10 has been removed from the surface 5. An example of such a system includes a pressure probe or other such mechanical switch. In this manner, the mouse 10 can stop imaging when moved off of the surface 5, such as when moved from one desk to another surface, without affecting the motion detected on an attached computer. However, it is understood that other types of systems can be used or developed which detect a relative vertical motion of the mouse 10 relative to the surface 5. Moreover, it is noted that such a system need not be used in all aspects.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical navigation module comprising:
a body having a base which rests on a surface with respect to which the optical navigation module moves;
a lens disposed in the body and having a large depth of field that is longer than a distance between the lens and the surface so as to form an image of another surface other than the surface;
a light sensor disposed in the body and which detects the formed image of the another surface; and
a controller to use the detected image to determine a motion of the another surface relative to the optical navigation module and which is independent of the surface on which the base rests.

2. The optical navigation module of claim 1, wherein the surface is transparent and is between the body and the another surface being imaged by the lens.

3. The optical navigation module of claim 2, wherein the surface comprises a desktop of a desk, and the another surface is a floor on which the desk rests.

4. The optical navigation module of claim 3, wherein the lens focuses light on the floor through a window in the base and through the transparent desktop surface.

5. The optical navigation module of claim 1, wherein the body is between the another surface and the surface.

6. The optical navigation module of claim 3, wherein the surface comprises a desktop of a desk, and the another surface is a ceiling of a room including the desk.

7. The optical navigation module of claim 1, wherein the controller detects the motion without an image of the surface.

8. The optical navigation module of claim 1, wherein the lens has a depth of field that is greater than a distance between the lens and the surface.

9. The optical navigation module of claim 1, wherein the lens has a depth of field that is up to infinity.

10. The optical navigation module of claim 8, wherein the lens has a depth of field that is up to infinity.

11. The optical navigation module of claim 1, wherein the depth of field is 25 cm to infinity.

12. The optical navigation module of claim 1, further comprising a lift-off detection system which detects when the body has been removed from the surface, and the controller stops detecting the motion when the lift-off detection system detects that the body has been removed from the surface.

13. The optical navigation module of claim 1, wherein the light sensor comprises an 800 count per inch sensor.

14. The optical navigation module of claim 1, wherein the light sensor comprises a CMOS sensor.

15. The optical navigation module of claim 1, further comprising a light source which illuminates the another surface.

16. The optical navigation module of claim 15, wherein the light source comprises a light emitting diode (LED).

17. The optical navigation module of claim 15, wherein the controller controls the light source to be on when there is insufficient ambient light to determine the motion and controls the light source to be off when there is sufficient ambient light.

18. The optical navigation module of claim 15, further comprising a user input to allow a user to control the light source to be on and control the light source to be off.

19. A computer mouse for use in providing motion detection for use in inputting data with respect to a computer, the mouse comprising:
a body having a base which rests on a surface with respect to which the optical navigation module moves;
a lens disposed in the body and having a large depth of field that is longer than a distance between the lens and the surface so as to form an image of another surface other than the surface;
a light sensor disposed in the body and which detects the formed image of the another surface; and
a controller to use the detected image to determine a motion of the another surface relative to the optical navigation module and which is independent of the surface on which the base rests, and to transmit the determined motion to the computer.

20. The computer mouse of claim 19, wherein the computer mouse comprises a wireless transmitter and receiver to transmit and receive data with respect to a computer.
